(19) United States
(12) Patent Application Publication
(10) Pub. No.: US 2023/0125551 A1
(43) Pub. Date: Apr. 27, 2023

(54) Emergency Power System

(71) Applicant: Energy Harness Power Systems, LLC, Cape Coral, FL (US)

(72) Inventor: Michael Fischer, Babcock Ranch, FL (US)

(21) Appl. No.: 17/973,932

(22) Filed: Oct. 26, 2022

Related U.S. Application Data
(60) Provisional application No. 63/271,875, filed on Oct. 26, 2021.

(51) Int. Cl. H02J 9/06; H02J 7/00

(52) U.S. Cl. CPC H02J 9/061; H02J 7/007; H02J 2207/20

(57) ABSTRACT

A centralized or decentralized backup power system comprising: a battery for storing power; an AC-to-DC power converter to convert mains A/C power into stored D/C power; a D/C battery charger; at least one current throttle control; and a power loss sensor; wherein when the power loss sensor detects a power loss, stored power from the battery is passed through a circuit that can divide the stored power into multiple delivery circuits; wherein the multiple circuits deliver a power stream to one or more downstream connected devices; and wherein the current throttle control delivers an appropriate amount of current to the downstream connected devices.

### BACKGROUND OF THE INVENTION

The present invention is directed to an emergency power system. More particularly, it is directed to an emergency power backup system that can be placed into existing power systems in buildings and can be safely maintained and/or serviced without the need of a certified electrician.

Most commercial facilities and buildings have a dedicated high voltage A/C (alternating current) “emergency power circuit” that is used throughout the building to charge battery backup equipment and to trigger the emergency lighting when the facility A/C power is lost. In facilities without emergency generators, all emergency lights are connected to battery systems, which in turn are connected to and monitor this emergency power circuit for outages. A power outage or loss on this circuit means the emergency system is activated and every emergency light should be operational.

The existing battery backup systems for emergency lighting are staged and configured to power a one-to-one “battery to light” ratio. Meaning each emergency light is driven by its own independent battery and monitoring circuit, attached to each fixture or lamp. Each of these battery systems are independently connected to the A/C emergency power circuit.

There are problems with this existing system of battery unit setup and lighting configuration. (1) Each battery unit is connected to and can only service a single fixture or light. This leads to having multiple individual battery units across the building or facility. (2) Each battery unit is connected directly to high voltage A/C emergency circuit (for example typically 277VAC in the USA). When battery replacement is necessary, it is a difficult task because the power circuit must remain energized so that all the other battery systems in the building do not engage and operate on battery power. (3) Under normal conditions, the effective lifespan of the batteries in the current systems is limited. Each battery unit which contains the battery, charger, and test button circuit must be individually disconnected from A/C and replaced every two or three years for general maintenance. Because it is connected to the high voltage A/C emergency power circuit, a certified electrician is required to replace the battery unit. Parts and labor together make each replacement expensive. (4) When replacing the battery unit, the lighting side connection, the test switch, and the A/C power side connection must all be disconnected and replaced on each battery unit. This makes the battery unit replacement dangerous, time consuming and expensive. (5) If there is an emergency power outage lasting for many hours or even several days, most batteries units will deplete beyond recharge and therefore all units will require that replacements be installed. (6) The typical cost of each individual battery unit is expensive, and this is especially evident when the cost is multiplied across the total number of emergency lights located at each facility.

### SUMMARY OF THE INVENTION

The invention is directed to a centralized or decentralized backup power system comprising: a battery for storing power; an AC-to-DC power converter to convert mains A/C power into stored D/C power; a D/C battery charger; at least one current throttle control; and a power loss sensor; wherein when said power loss sensor detects a power loss, stored power from said battery is passed through a circuit that can divide said stored power into multiple delivery circuits; wherein said multiple circuits deliver a power stream to one or more downstream connected devices; and wherein said current throttle control delivers an appropriate amount of current to the downstream connected devices.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a circuit diagram of the power system of the present invention,

FIG. 2 is a circuit diagram of the present invention when providing back up power,

FIG. 3 is a circuit diagram of the present invention during charging, and

FIG. 4 is a circuit diagram of a close up view of the of a test switch of the present invention.

### DETAILED DESCRIPTION OF THE INVENTION

The present invention is directed to an emergency power system that provides a direct current (DC) power connection to light multiple emergency lights within existing systems connected directly to A/C power.

The better way to deploy an emergency lighting battery system is by the one-to-many approach, where each battery system can simultaneously power multiple emergency lights, across the building or facility rather than the one-to-one approach currently in use. Since each light (or device powered) may require a different amount of voltage or current, this issue is covered by using a modular constant current throttling approach where each power channel can be set to individual emergency device requirements.

The shared battery replacement procedure is greatly improved by providing a power shutoff mechanism that allows for a breaker switch device to cut the high voltage A/C power to the battery charging system. This allows for only the battery itself to be safely removed and replaced and not the entire battery system. The emergency lighting remains connected, the A/C power remains connected, the emergency power circuit remains on, and only the battery is replaced. This improved method allows for maintenance personnel to safely replace the battery without requiring a certified electrician to disconnect the high voltage A/C power.

The solution to improve the current individual battery unit system, is to use a shared system for the lighting configuration are as follows:
a) Each battery system is shared across multiple emergency lights which greatly reduce the total battery units required throughout the building or facility.
b) Each battery system is shared across multiple emergency lights which greatly reduce the total labor required to service and maintain the system throughout the building or facility.
c) A shutoff mechanism is provided to disconnect from the high voltage A/C emergency circuit which allows for safe battery replacement to be performed while the high voltage A/C emergency circuit is still energized for the rest of the facility. This single point to repair covers multiple emergency lights simultaneously while the emergency circuit is fully energized.
d) When battery replacement maintenance is due, it is a simple and safe procedure to replace only the battery while leaving the system infrastructure connected to both A/C and D/C circuits. This service can be safely performed by maintenance personnel without requiring a certified electrician.
e) The lighting side emergency test switch remains connected during maintenance and the entire system can be tested from any emergency light location.
f) If there is an emergency power outage lasting for many hours or even days, most batteries units will deplete beyond recharge. This novel system minimizes the number of replacement batteries required. This novel system also minimizes the amount of time and labor required to get all the emergency lighting back operational. In addition, during the power outage, batteries can be replaced with new, fully charged batteries so that the old batteries are not depleted beyond recharge and can therefore be reused later.
g) The cost of the current individual battery unit is typically expensive, and this is especially evident when the cost is multiplied across the total number of emergency lights located at each facility. This novel emergency battery system combines multiple emergency lights into a shared system that lowers the entire system cost across the facility.

This invention takes in and utilizes mains power. It monitors existence of mains power, as well as absence of mains power via a relay switch. It monitors voltage level of mains power to predetermine the minimum voltage required to trip emergency power over to the emergency side of the backup device.

Within the emergency power system, energy from the mains power is transitioned into a storable format as the electricity from mains is brought into the power system, converted to DC, sent to a monitoring charger device, which then stores the appropriate voltage in a battery, capacitor bank or other electrical storage medium. While mains power is present, the emergency power system will continue to charge, store, and maintain the electrical potential in the storage system. Power storage will be kept at full capacity. When capacity is reached, the charging system will maintain the storage through a monitor, and charge maintenance method.

When a mains power outage occurs, stored energy is instantly transferred from the power system energy bank to the electronic current throttle. The electronic current throttle then delivers electricity through each preset channel over to multiple, centralized or decentralized, electronic devices. The electronic current throttle holds back the stored electrical potential while only delivering a precise stream of energy to the connected electronic devices. Controlling the delivery from the larger storage mechanism to the electrical consuming devices allows for a planned long-term delivery time scheme.

This electronic current throttle is accomplished by a circuit board, DC-DC converters, and multi-channel panel connectors. The circuit board routes the stored power to all channels on the circuit board that each include and utilize a preset DC current throttle to match the predetermined current/amperage required by the electronic device. The DC-DC converters transfer power from a storage mechanism where the electrical potential is stored at a specific voltage and amperage ratio, to the electrical consuming device specific and predetermined voltage and amperage ratio. This regulates power delivery to maintain a steady stream of power to connected device.

The multi-channel panel connectors (gatekeepers of current flow) are gated with a diode or similar type device for preventing reverse current flow.

Channels are dedicated to send a positive D/C circuit leg to the light, a negative D/C circuit leg to the light, a positive D/C circuit leg to emergency test switch and a return D/C circuit leg from emergency test switch. This configuration allows for a light that is connected to the Emergency Battery Back up System, to be checked and tested via an emergency light test switch during maintenance and inspection.

Any emergency test switch when pushed can cause the emergency power system to simulate a power outage in the facility.

Upon detection of a power outage, the stored electrical energy from the emergency storage system is sent to the primary circuit board. The primary circuit board receives D/C power from the storage source (e.g., battery) and uses it to adjust, throttle and deliver the appropriate predetermined voltage and amperage ratio, as well as total output, to the connected electronic devices. This means the invention can deliver a desired current using the current throttle system.

Key features of the present invention that are unique:
1. Passing the stored power through a single circuit that can divide it into multiple delivery circuits. Then using the multiple circuits to deliver a predetermined or real time adjustable power stream to the connected devices.
2. The throttle mechanism can be preset or real time programmable, to deliver the appropriate amount of current to the electronic devices.
3. The power from the circuit board passes the internal gatekeeper multi-channel switch, through a multi-pair, copper wire cabling system (such as a (category-5,6,7 ethernet cable) and is directed to the electronic device.
4. When the CAT5/6 cable reaches the electronic device, the system bypasses the A/C input, going directly to the D/C input for the electronic device. (Typically, this means emergency lighting, but it can refer to any emergency electronic device).

The system operates by attaching a switch on the D/C input of the electronic device. The switch is a multi-channel panel connector that provides a gatekeeper function (used both internally in the system of the present invention as well as on the D/C input of the electrical device). This means that not only current is delivered appropriately to the electronic device, but it is also directionally controlled, preventing any damaging back-feed of electrical current to or from the power system. This gatekeeping switch is installed at the D/C input of the electronic device.

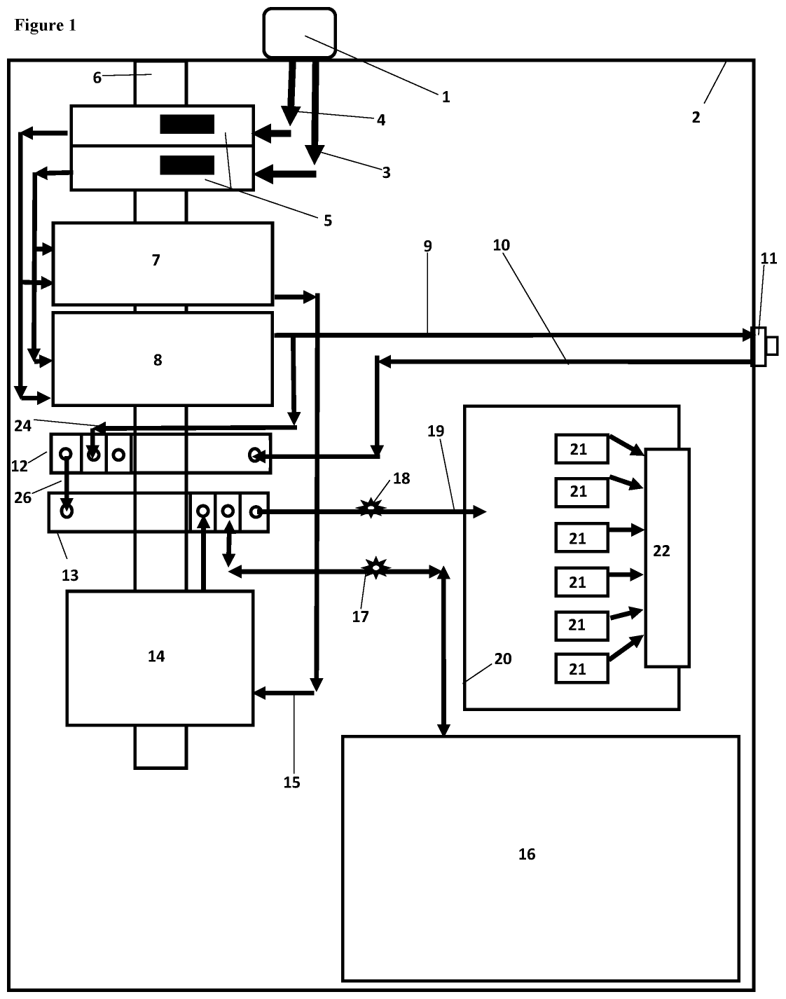

As shown in FIG. 1, a facilities A/C mains 120-277VAC (volts alternating current) power 1 enters the secured metal housing 2 of the Emergency Battery Backup System (EBBS). Neutral 4 and line/hot 3 A/C power legs enter a series of breakers 5 which acts as an internal high voltage safety shut off within the EBBS. The breakers 5, DC voltage bus A 7 (responsible for providing 15v power to a battery charger 14), DC voltage bus B 8 (responsible for providing 24v power to the push button test relay 12), push button test relay 12, DC voltage bus B relay 13, and the battery charging circuit 14 are secured to a mounting rail 6 located within the EBBS metal housing 2.

Once the A/C mains line 3 and neutral 4 pass through the breakers 5, power is then connected to the input of the DC voltage bus A 7 and the DC voltage bus B 8 power supplies, which on the outbound side, converts the high A/C voltage to low D/C voltage. From here on out, this EBBS unit is a low voltage system, meaning that no high A/C voltage flows within the circuitry beyond this point. This feature allows for safe maintenance as well as allows for any facility maintenance crew member to conduct work or repair on this EBBS without the requirement of a certified electrician.

Voltage bus A 7 is directly responsible for providing input voltage to the battery charger circuit 14. The battery charger circuit 14 regulates charge flow and amount to a battery 16 (for example but not limited to a, 12VDC 18 Amp hour (Ah)), ensuring the battery 16 is appropriately charged an undamaged due to over or under charging.

Voltage bus B 8 is directly responsible for providing an input voltage to the Test Push Button 11 as well as a voltage bus B control line 24 that powers the push button test relay 12 and a voltage bus B relay 13.

The test push button 11 allows the user to simulate a power outage and test the EBBS. Once the button is pressed, a connection disruption is simulated within the EBBS, which simulates the power outage. Once the power is out, whether through use of the test button, or a power failure, the DC voltage bus B relay 13 switches the directional flow state from “battery charging” to “battery delivering emergency power”.

Active charging of the EBBS can be indicated by a red LED indicator light 17. Active emergency power delivery can be indicated by a green LED indicator light 18. (Any color LED can be used. Red and green are described here only as an example.)

When the EBBS is in operation, meaning the system is delivering emergency power to a series of electronic devices, the power from the charged battery 16 is delivered to a circuit board 20 that contains a series of separate current throttles 21. These current throttles 21 can be preset to deliver a specific current to a specific electronic device, allowing the EBBS to be an emergency power solution for a multitude of electronic devices within one system. After the power is passed through the current throttles 21, it is delivered to the electronic devices via a 2-way Power over Ethernet (PoE) or Lighting over Ethernet (LoE) interface 22 that is compatible with CAT5/6 ethernet (or cable of similar design).

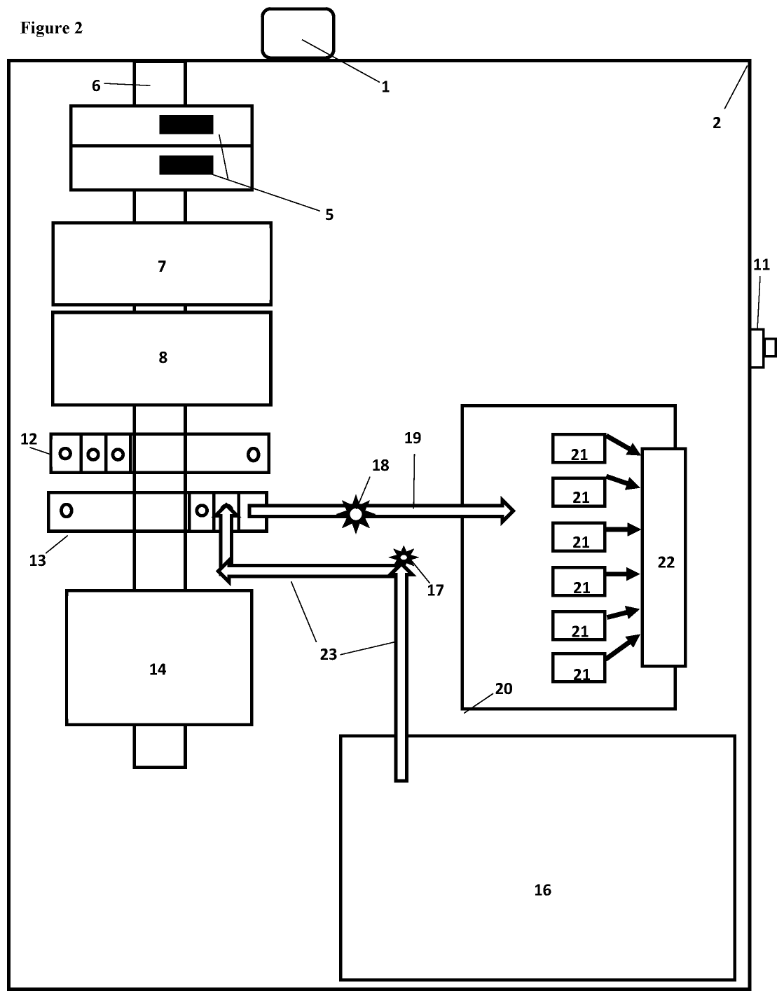

FIG. 2 shows the flow of electricity within the EBBS circuit when emergency power is being delivered to the electronic devices of interest. Emergency power leaves the charged battery 16 via DC voltage bus B relay-to-battery connection 23. With mains A/C power 1 out, the push button test relay 12 and the DC voltage bus B relay 13 are switched from the normally open position, which allows for the flow of electricity to the battery charging circuit 14 and charges the Battery 16, to the closed position, which redirects the flow of electricity to send the charged emergency power from the battery 16 to the circuit board 20. The battery input flows down the DC voltage bus B relay 13 to circuit board connection 19, powering a green LED indicator light 18 in the process. The illumination of the LED indicator light 18 is evidence that emergency power is being delivered to the circuit board 20. The emergency power enters individual current throttles 21, where it is then distributed to a series of electronic devices via a 2-way PoE or LoE switch system 22.

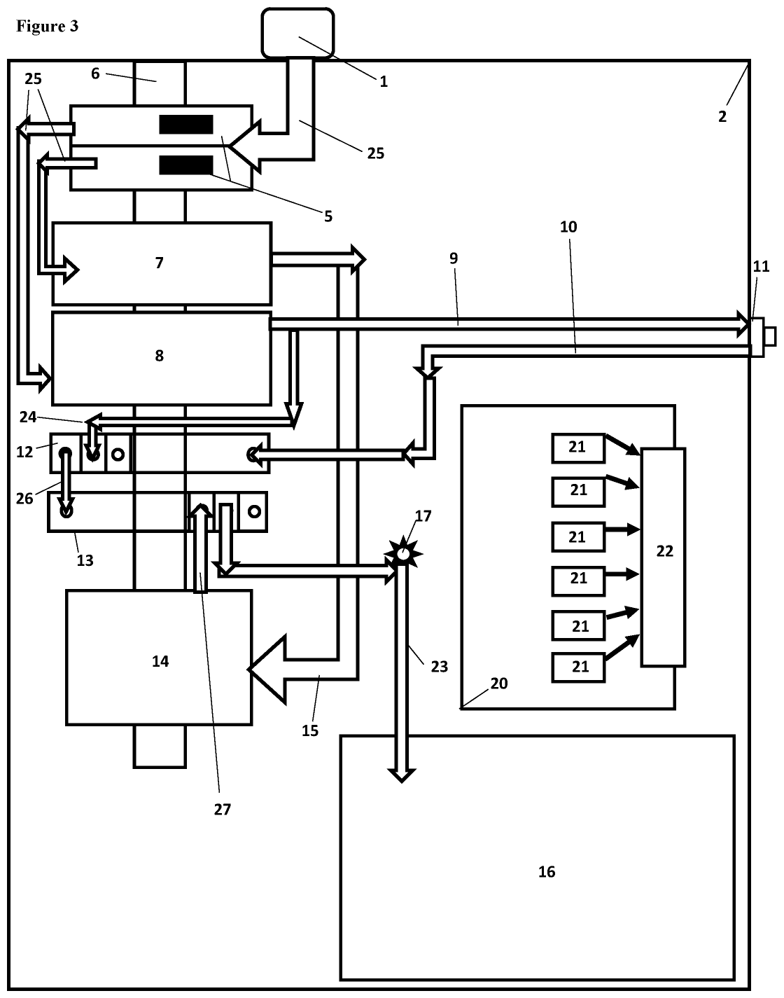

FIG. 3 shows the flow of electricity within the EBBS circuit when charging of the systems emergency battery system 16 is active. Mains A/C power 1 enters the EBBS metal containment housing 2 and connects through a series of 277VAC breakers 5. The flow of electricity 25 travels to the input of the DC voltage bus A 7 and the DC voltage bus B 8.

On the outbound side of the DC voltage bus A 7 and the DC voltage bus B 8, the flow of electricity branches out through the test push button 11, the test push button relay 12, and the battery charging circuit 14. The battery charging circuit 14 is connected to the outbound of the DC voltage bus A 7 via a DC voltage bus A charging input line 15 as well as connected to a battery 16 through a DC voltage bus B relay 13 through the battery charger-to-DC voltage bus B relay line connection 27. The DC voltage bus B control line 24 that begins on the outbound side of the DC voltage bus B 8, powers the push button relay 12, which is connected in line with the DC voltage bus B relay 13 via a relay-to-relay connection 26.

Following the flow from battery charging circuit 14 through the battery charger-to-DC voltage bus B relay line connection 27, into the DC voltage bus B relay 13, back out the DC voltage bus B relay 13 along the DC voltage bus B relay-to-battery connection 23, through the red LED battery charging indicator light 17, and finally into the battery 16 completes the flow of electricity during the charging phase of the EBBS.

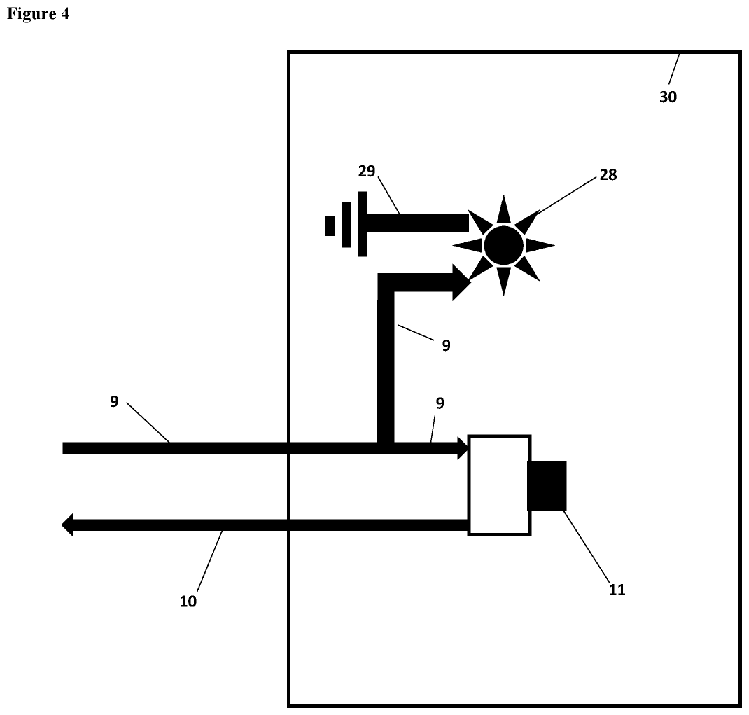

FIG. 4 shows a single gang electric box plate cover 30 that holds the emergency test push button 11, as well as the emergency test indicator LED light 28. This figure is designed to give a closer look at the direct wiring and current flow when the test button 11 is pressed. A direct DC voltage bus B line out to push-button test switch line 9 carries a corresponding voltage from the DC voltage bus B 8 (See FIGS. 1-3) to the test button 11 as well as the test indicator LED light. The test button 11 is in the normally open position. This means when the test button 11 is pressed, the return DC voltage bus B line 10 interrupts or closes the circuit. This action prevents power flow to the push button test relay 12 (See FIGS. 1-3), which, in turn, prevents power to flow to the DC voltage bus B relay 13 (See FIGS. 1-3). The lack of power from both relays simulates a mains A/C power outage, with a successful test of emergency power delivery validated by the emergency test indicator LED light 28.

The emergency test indicator LED light 28 will short out through the ground line 29 when the test button 11 is pressed. When the test push button 11 is pressed and the circuit is completed, the test indicator LED light 28 will not emit light, indicating that the EBBS does not have AC power (See FIG. 2) and that the emergency backup power is being delivered to the Circuit Board 20 (See FIGS. 1-3), which, in turn, provides emergency power to the specified electronic devices. When the test push button 11 is not pressed, the test indicator LED light 28 will emit light, indicating power is running through the system and charging the battery 16 (See FIGS. 1-3) and emergency backup power is not being delivered to the specified electronic devices.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated.

What is claimed is:

1. A centralized or decentralized backup power system comprising:
a battery for storing power;
an AC-to-DC power converter to convert mains A/C power into stored D/C power;
a D/C battery charger;
at least one current throttle control; and
a power loss sensor;
wherein when said power loss sensor detects a power loss, stored power from said battery is passed through a circuit that can divide said stored power into multiple delivery circuits;
wherein said multiple circuits deliver a power stream to one or more downstream connected devices; and
wherein said current throttle control delivers an appropriate amount of current to the downstream connected devices.

2. An Emergency Battery Backup System (EBBS) that provides a centralized means of emergency power to at least one electronic device in an area, and provides a decentralized placement means of multiple EBBS systems that are each responsible for providing emergency power to at least one electronic device within the designated area of said EBBS systems.

3. An Emergency Battery Backup System (EBBS) that delivers a specific and individual current level to a specified connected electronic device, where said connected electronic device has an adjustable current throttle level that can be preset or adjusted during operation.
